(19) United States
(12) Patent Application Publication
(10) Pub. No.: US 2025/0150158 A1
(43) Pub. Date: May 8, 2025

(54) RELAY DEVICE, BASE STATION DEVICE, AND RELAY METHOD

(71) Applicant: FUJITSU LIMITED, Kawasaki-shi (JP)

(72) Inventors: Ryosuke KOBAYASHI, Kawasaki (JP); Yosuke AKIMOTO, Ichihara (JP); Takako HORI, Sagamihara (JP)

(73) Assignee: FUJITSU LIMITED, Kawasaki-shi (JP)

(21) Appl. No.: 19/006,370

(22) Filed: Dec. 31, 2024

Related U.S. Application Data
(63) Continuation of application No. PCT/JP2022/030192, filed on Aug. 5, 2022.

(51) Int. Cl. H04B 7/155; H04W 48/08; H04W 48/16

(52) U.S. Cl. CPC H04B 7/15557; H04W 48/08; H04W 48/16

(57) ABSTRACT

A relay device of relaying a signal received from a base station device to a terminal device includes: a controller configured to determine whether or not to perform relay processing of a first signal transmitted by a first base station device under control of the first base station device according to support information that indicates whether or not the first base station device has a control function of the relay device; and relay processor circuitry configured to perform the relay processing under the control of the first base station device in a case where the controller determines to perform the relay processing under the control of the first base station device, wherein the relay processing includes amplification and transfer processing of the first signal.

### CROSS-REFERENCE TO RELATED APPLICATION

This application is a continuation application of International Application PCT/JP2022/030192 filed on Aug. 5, 2022 and designated the U.S., the entire contents of which are incorporated herein by reference.

### FIELD

The embodiments discussed herein are related to a relay device, a base station device, and a relay method.

### BACKGROUND

In a radio communication system, radio communication is implemented by, for example, a terminal device receiving signals (radio waves) transmitted from a base station device. However, depending on a location of the terminal device, the radio waves from the base station device may not reach (fail to be received by the terminal device). Therefore, there is a relay device referred to as a repeater that amplifies and transmits the radio waves received from the base station device. By installing the repeater, a user may transmit the amplified radio waves to a dead zone where the radio waves do not reach because the dead zone is located in a shadow of a building or an object or far away from the base station device, or the like, and it is possible to reduce an area where the terminal device may not perform radio communication.

However, the repeater simply only amplifies the radio waves, and may not perform beam forming in a direction of the terminal device, transmission control of the amplified radio waves, and the like. Therefore, a network controlled repeater (NCR), which is a highly functional repeater having a control function from a base station device and a beam forming function, has been considered in Rel-18 of a third generation partnership project (3GPP (registered trademark)).

Technologies related to the repeater and the NCR are described in the following related art documents.

3GPP TS36.133 LTE-A Radio Measurement Specification, 3GPP TS36.300 LTE-A General Specification, 3GPP TS36.211 LTE-A PHY Channel Specification, 3GPP TS36.212 LTE-A PHY Coding Specification, 3GPP TS36.213 LTE-A PHY Procedure Specification, 3GPP TS36.214 LTE-A PHY Measurement Specification, 3GPP TS36.321 LTE-A MAC Specification, 3GPP TS36.322 LTE-A RLC Specification, 3GPP TS36.323 LTE-A PDCP Specification, 3GPP TS36.331 LTE-A RRC Specification, 3GPP TS36.413 LTE-A S1 Specification, 3GPP TS36.423 LTE-A X2 Specification, 3GPP TS36.425 LTE-A Xn Specification, 3GPP TR36.912 NR Radio Access Overview, 3GPP TR38.913 NR Requirements, 3GPP TR38.913 NR Requirements, 3GPP TR38.801 NR Network Architecture Overview, 3GPP TR38.802 NR PHY Overview, 3GPP TR38.803 NR RF Overview, 3GPP TR38.804 NR L2 Overview, 3GPP TR38.900 NR High Frequency Overview, 3GPP TS38.300 NR General Specification, 3GPP TS37.340 NR Multi-Connectivity General Specification, 3GPP TS38.201 NR PHY Specification General Specification, 3GPP TS38.202 NR PHY Service General Specification, 3GPP TS38.211 NR PHY Channel Specification, 3GPP TS38.212 NR PHY Coding Specification, 3GPP TS38.213 NR PHY Data Channel Procedure Specification, 3GPP TS38.214 NR PHY Control Channel Procedure Specification, 3GPP TS38.215 NR PHY Measurement Specification, 3GPP TS38.321 NR MAC Specification, 3GPP TS38.322 NR RLC Specification, 3GPP TS38.323 NR PDCP Specification, 3GPP TS37.324 NR SDAP Specification, 3GPP TS38.331 NR RRC Specification, 3GPP TS38.401 NR Architecture General Specification, 3GPP TS38.410 NR Core Network General Specification, 3GPP TS38.413 NR Core Network AP Specification, 3GPP TS38.420 NR Xn Interface General Specification, 3GPP TS38.423 NR XnAP Specification, 3GPP TS38.470 NR F1 Interface General Specification, 3GPP TS38.473 NR F1AP Specification, and RP-213700 are disclosed as related art.

### SUMMARY

According to an aspect of the embodiments, there is provided a relay device of relaying a signal received from a base station device to a terminal device, the relay device including: a control unit configured to determine whether or not to perform relay processing of a first signal transmitted by a first base station device under control of the first base station device according to support information that indicates whether or not the first base station device has a control function of the relay device; and a relay unit configured to perform the relay processing under the control of the first base station device in a case where the control unit determines to perform the relay processing under the control of the first base station device, wherein the relay processing includes amplification and transfer processing of the first signal.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an example of radio communication in a radio communication system 10;

FIG. 2 is a diagram representing a software configuration example of a relay device 300 in the radio communication system 10;

FIG. 3 is a diagram illustrating a configuration example of the relay device 300;

FIG. 4 is a diagram representing a configuration example of a base station device 200;

FIG. 5 is a diagram illustrating an example of a sequence of relay processing in the relay device 300;

FIG. 6 is a diagram illustrating an example of a sequence of the relay processing in the relay device 300;

FIG. 7 is a diagram illustrating an example of a sequence of the relay processing in the relay device 300;

FIG. 8 is a diagram illustrating an example of a sequence of the relay processing in the relay device 300;

FIG. 9 is a diagram illustrating an example of a change in TS 38.304;

FIG. 10 is a diagram illustrating an example of a content change in TS 38.304;

FIG. 11 is a diagram illustrating an example of a content change in TS 38.331; and

FIG. 12 is a diagram illustrating an example of a content change in TS 38.331.

### DESCRIPTION OF EMBODIMENTS

In the related art, the NCR is under the consideration, and detailed processing contents have not yet been determined. For example, in a case where a base station device that is not compatible with NCR control and a base station device that is compatible with the NCR control are mixed, which cell (base station device) the NCR selects as an amplification object has not been determined.

Therefore, one disclosure provides a relay device, a base station device, and a relay method capable of appropriately selecting a cell to be amplified by an NCR in a communication system in which base station devices that are not compatible or compatible with NCR control are mixed.

### First Embodiment

A first embodiment will be described.

### <Radio Communication System 10>

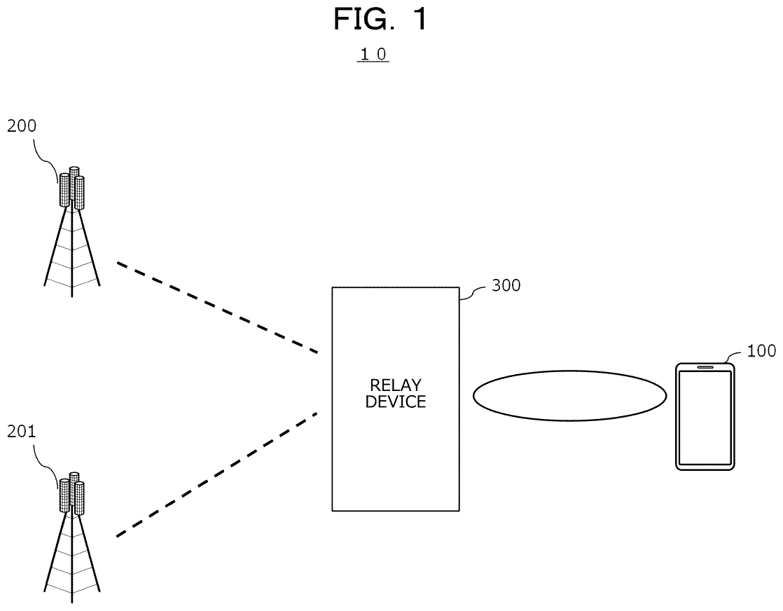

FIG. 1 is a diagram illustrating a configuration example of a radio communication system 10. The radio communication system 10 includes a base station device 200, a base station device 201, a relay device 300, and a terminal device 100.

The terminal device 100 is a communication device that is wirelessly coupled to the base station device 200 and the base station device 201 to transmit and receive data, and is, for example, a smartphone or a tablet terminal. Furthermore, the terminal device 100 is wirelessly coupled to the relay device 300 to communicate with the base station device 200 and the base station device 201 via the relay device 300.

The base station device 200 and the base station device 201 are devices that are wirelessly coupled to the terminal device 100 to perform radio communication, and are, for example, evolved Node B (eNodeB) or next generation Node B (gNodeB). The base station device 200 and the base station device 201 are compatible with, for example, various generations of communication (for example, a fourth generation (4G), a fifth generation (5G), a Beyond 5G, or the like). Furthermore, the base station device 200 and the base station device 201 may be formed with one device, or may be formed with a plurality of devices such as a central unit (CU) and a distributed unit (DU).

The base station device 200 and the base station device 201 mount applications of versions different from each other. The base station device 200 mounts an application of a version (new version) compatible with control of the relay device 300. On the other hand, the base station device 201 mounts an application of a version (old version) not compatible with control of the relay device 300. For example, the radio communication system 10 is a communication system in which the base station device 200 and the base station device 201 of the old and new versions are mixed.

The relay device 300 is a device that receives radio waves from the base station device 200 and the base station device 201 and transmits the amplified radio waves by beam forming, and is, for example, a network controlled repeater (NCR). The relay device 300 is controlled by the base station device 200 as to whether or not to perform relay, a direction and intensity of the beam forming, and the like. In a case where radio waves transmitted from a plurality of the base station devices 200 and the base station devices 201 are received, the relay device 300 determines whether or not to relay the radio waves, or the like for each of the base station devices. Note that the radio waves (signals) that may be amplified by the relay device 300 may be compatible with the plurality of base station devices 200 and base station devices 201, but in the present embodiment, it is assumed that the radio waves (signals) that may be amplified by the relay device 300 may be compatible with one base station device 200 or base station device 201.

### <Software Configuration Example of Relay Device 300>

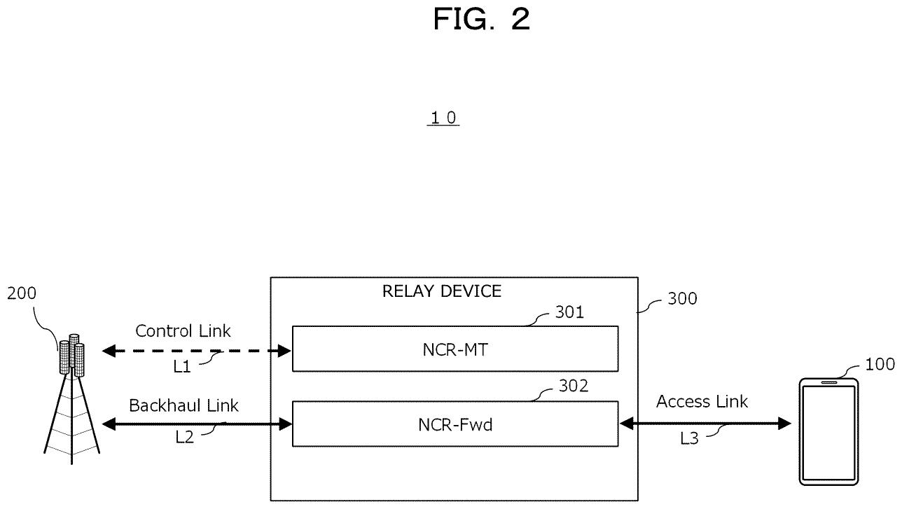

FIG. 2 is a diagram representing a software configuration example of the relay device 300 in the radio communication system 10. The relay device 300 includes an NCR-mobile termination (MT) 301 and an NCR-forwarding (Fwd) 302.

The NCR-MT 301 is a control unit that wirelessly communicates with the base station device 200 via a control link L1 and enables transmission and reception of side control information and the like. For the control link L1, for example, a Uu interface of new radio (NR) is used. Note that the side control information includes, for example, information related to control of the NCR-Fwd 302 described below.

The NCR-Fwd 302 is a relay unit that executes amplification and transfer of signals (radio waves) between the base station device 200 and the terminal device 100 via a backhaul link L2 and an access link L3. The NCR-Fwd 302 determines processing according to the side control information received from the base station device 200. Note that the transfer includes amplifying signals received from the base station device 200 and transmitting the amplified signals to the terminal device 100, and amplifying signals received from the terminal device 100 and transmitting the amplified signals to the base station device 200.

Note that, hereinafter, the relay includes relay processing in a control mode and relay processing in an autonomous mode. Moreover, the relay includes processing such as signal amplification, beam forming, and signal transfer.

### <Configuration Example of Relay Device 300>

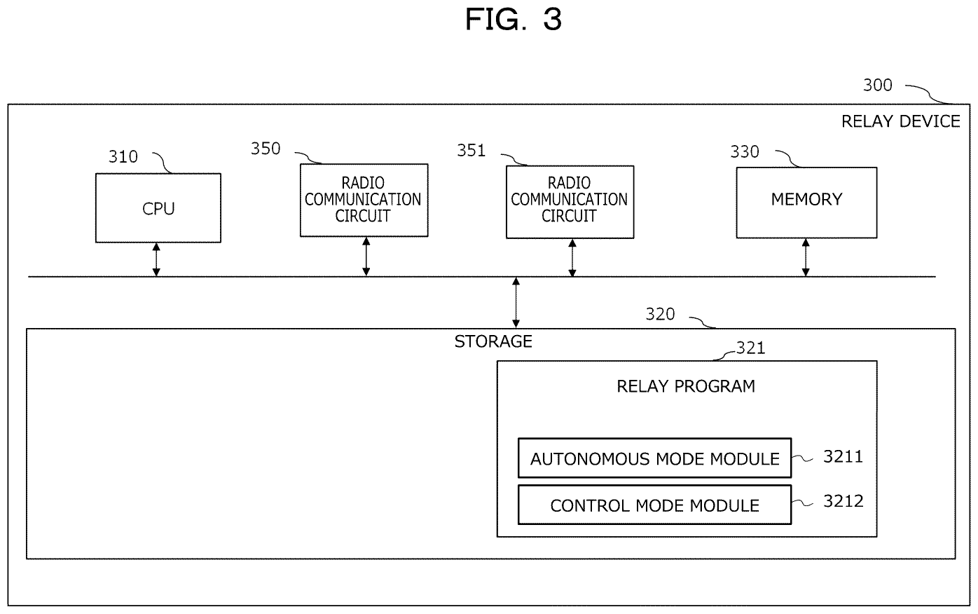

FIG. 3 is a diagram illustrating a configuration example of the relay device 300. The relay device 300 includes a central processing unit (CPU) 310, a storage 320, a memory 330, a radio communication circuit 350, and a radio communication circuit 351.

The storage 320 is an auxiliary storage device that stores programs and data, such as a flash memory, a hard disk drive (HDD), or a solid state drive (SSD). The storage 320 stores a relay program 321.

The memory 330 is an area in which a program stored in the storage 320 is loaded. Furthermore, the memory 330 may also be used as an area in which the program stores data.

The radio communication circuit 350 is a device that performs radio communication with the base station device 200 and the base station device 201. The relay device 300 transmits and receives signals to and from the base station device 200 and the base station device 201 via the radio communication circuit 350. For example, the NCR-MT 301 and the NCR-Fwd 302 illustrated in FIG. 2 may receive signals from the base station device 200 and the base station device 201 via the radio communication circuit 350 illustrated in FIG. 3.

The radio communication circuit 351 is a device that performs radio communication with the terminal device 100. The relay device 300 transmits and receives signals to and from the terminal device 100 via the radio communication circuit 351. The radio communication circuit 351 includes, for example, a directional antenna capable of controlling directions of transmission and reception of radio waves. The radio communication circuit 351 may perform, for example, transmission of signals at a radio wave intensity specified by the control unit and beam forming for specifying a transmission direction. For example, the NCR-Fwd 302 illustrated in FIG. 2 may transmit and receive signals to and from the terminal device 100 via the radio communication circuit 351 illustrated in FIG. 3.

The CPU 310 is a processor that loads a program stored in the storage 320 into the memory 330 and executes the loaded program to construct each unit and implement each processing.

By executing the relay program 321, the CPU 310 constructs the control unit and the relay unit to perform the relay processing. The relay processing is processing of receiving signals from the base station device 200 and the base station device 201 and performing relay (amplification and transfer). The relay processing includes determination as to whether or not to perform the relay processing. Furthermore, the relay processing includes the relay processing in the autonomous mode and the relay processing in the control mode. Details of the autonomous mode and the control mode will be described later.

By executing an autonomous mode module 3211 included in the relay program 321, the CPU 310 constructs the relay unit to perform autonomous mode processing. The autonomous mode processing is processing of performing relay in the autonomous mode.

By executing a control mode module 3212 included in the relay program 321, the CPU 310 constructs the relay unit to perform control mode processing. The control mode processing is processing of performing relay in the control mode.

### <Configuration Example of Base Station Device 200>

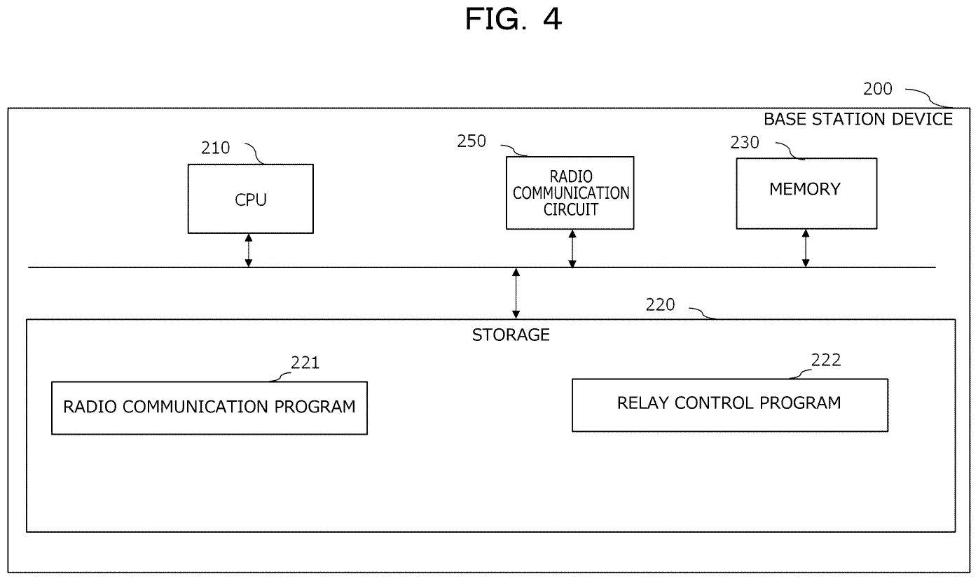

FIG. 4 is a diagram representing a configuration example of the base station device 200. The base station device 200 includes a CPU 210, a storage 220, a memory 230, and a radio communication circuit 250.

The storage 220 is an auxiliary storage device that stores programs and data, such as a flash memory, an HDD, or an SSD. The storage 220 stores a radio communication program 221 and a relay control program 222.

The memory 230 is an area in which a program stored in the storage 220 is loaded. Furthermore, the memory 230 may also be used as an area in which the program stores data.

The radio communication circuit 250 is a device that performs radio communication with the terminal device 100. Furthermore, the radio communication circuit 250 may perform radio communication with the relay device 300.

The CPU 210 is a processor that loads a program stored in the storage 220 into the memory 230 and executes the loaded program to construct each unit and implement each processing.

By executing the radio communication program 221, the CPU 210 constructs a communication unit to perform base station communication processing. The base station communication processing is processing of performing radio communication with the terminal device 100 and the relay device 300. In the base station communication processing, the base station device 200 is wirelessly coupled to the terminal device 100 and the relay device 300 to transmit signals to a transmission destination and receive signals.

By executing the relay control program 222, the CPU 210 constructs a relay control unit to perform relay control processing. The relay control processing is processing of controlling the relay processing performed by the relay device 300. In the relay control processing, the base station device 200 notifies (performs transmission to) the relay device 300 of information related to whether or not the own device has a control function of the relay device 300, sidelink control information, and the like.

### <Relay Processing>

The relay processing will be described. The relay processing is processing of determining whether or not to camp on when a signal is received from the base station device 200 or the base station device 201, and performing or not performing transfer according to the determination. Camping on indicates, for example, establishing the control link L1 with the base station device in order to perform transfer involving control. Determining to camp on a certain base station device may be regarded as determining to perform cell selection (cell reselection) on the certain base station device. In a case where the control link L1 is not established and transfer without control is performed, the relay device 300 does not camp on the base station device.

Hereinafter, each processing sequence will be described for a case where the base station device has the control function of the relay device 300 and a case where the base station device does not have the control function of the relay device 300.

### <1. Case of Base Station Device 200 Having Control Function>

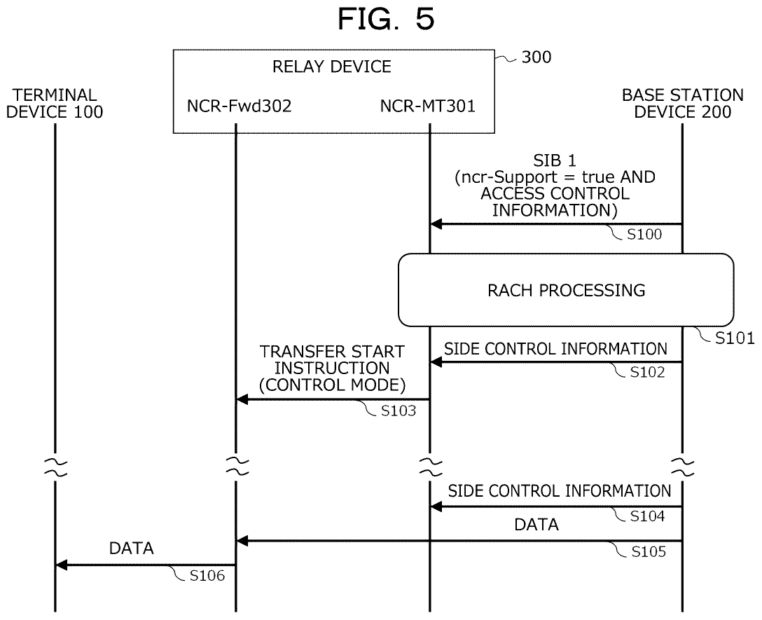

FIG. 5 is a diagram illustrating an example of a sequence of the relay processing in the relay device 300. In FIG. 5, the relay device 300 receives a signal from the base station device 200 having the control function of the relay device 300.

The base station device 200 transmits a system information block (SIB) 1 (S100). The SIB is, for example, information reported to a certain base station device 200 or the terminal device 100 under a certain cell. The SIB is transmitted using, for example, a physical downlink shared channel (PDSCH). The SIB 1 includes, for example, NCR support information (ncr-Support) indicating whether or not the control function of the relay device 300 is included, and access control information.

Note that the base station device 200 may notify that the control function of the relay device 300 is included (or not included) by a method other than transmission of the SIB 1. For example, the base station device 200 may notify that the control function of the relay device 300 is included using another report information or another message. Furthermore, for example, the relay device 300 may recognize in advance which base station device has the control function of the relay device 300 and perform determination based on an identifier of the base station device included in the signal.

In a case where the NCR support information is true, it is indicated that the base station device has the control function of the relay device 300. In FIG. 5, “ncr-Support=true”, and it is indicated that the base station device 200 has the control function of the relay device 300.

Note that, in a case where there is no ncr-Support or in a case where ncr-Support is set to other than true (for example, false), it is indicated that the base station device does not have the control function of the relay device 300.

The access control information includes, for example, information related to access such as permission/non-permission (possibility/impossibility) of access to the base station device and an access condition. For example, the following parameters are set as access restriction information.
cellBarred: a parameter related to access prohibition to the cell. In the case of Barred, it is indicated that access to the cell is prohibited.
cellReservedForOperatorUse: a parameter related to reservation by an operator. In the case of Reserved, it is indicated that access of a general user to the cell is prohibited.
cellReservedForFutureUse: a parameter related to reservation of use of the cell. In the case of True, it is indicated that access to the cell is prohibited.
intraFreqReselection: a parameter related to selection permission of the cell. In the case of notAllowed, it is indicated that access to the cell is prohibited.

Furthermore, the access control information includes, for example, restriction by closed access group (CAG)-identifiers (IDs) or network identifiers (NIDs) reported by the cell. Moreover, in the access control information, for example, a status of the cell includes information related to a future use (it is assumed to be used in the future, but it is not currently available).

Furthermore, the relay device 300 does not have to apply restriction based on unified access control (UAC).

The NCR-MT 301 of the relay device 300 receives the SIB 1 (S100), and determines whether or not to camp on the base station device 200.

For example, the NCR-MT 301 determines to camp on the base station device 200 based on only the NCR support information regardless of the access restriction information (even when access to the cell is prohibited). In a case where ncr-Support is true, the NCR-MT 301 determines to camp on the base station device 200. Furthermore, in a case where ncr-Support is false, the relay device 300 determines not to camp on the base station device 200.

Furthermore, in a case where access is not prohibited by the access restriction information and the NCR support information is true, the NCR-MT 301 may determine to camp on the base station device 200.

In FIG. 5, since the NCR support information is true, it is assumed that the NCR-MT 301 determines to camp on the base station device 200. Note that a sequence in a case where the NCR-MT 301 determines not to camp on the base station device 200 having the control function is a sequence similar to that in the case of the base station device 201 not having the control function indicated below.

When it is determined to camp on the base station device 200, the NCR-MT 301 performs random access channel (RACH) processing (S101). The RACH processing is processing performed by the relay device 300 to synchronize with the base station device 200, and is also referred to as a random access channel procedure (RACH procedure). The NCR-MT 301 performs the RACH processing S101 to establish the control link L1.

In the RACH processing S101, the NCR-MT 301 notifies the base station device 200 that the NCR-MT 301 is included in the relay device 300.

For example, in a case where an RRC_CONNECTED state (a state where a radio resource control (RRC) is connected) is entered but a signaling radio bearer (SRB: for example, used for transmitting an RRC message by using a dedicated control channel (DCCH)) 1 is not established, the NCR-MT 301 performs the notification by the following method.
Notify by a RACH preamble (RACH partitioning).
Notify by an Establishment cause.
High-order 39 bits of 5G-S-temporary mobile subscriber identity (TMSI)

used for a relay protocol (RP) are set to a fixed value to indicate that it is the relay device 300.

Note that, in a case where a radio link failure (RLF) is detected in a case where the RRC_CONNECTED state is entered but the SRB 1 is not established, for example, the NCR-MT 301 transitions from the RRC_CONNECTED state to an RRC_IDLE state (a state where the RRC is not connected), and transitions to the RRC_CONNECTED state again.

Furthermore, for example, in a case where the SRB 1 is established but security setting is not performed, the NCR-MT 301 performs the notification by the following method in addition to the three methods described above.
Notify by an RRCSetupComplete message.

Note that capability of the relay device 300 may be included in the RRCSetupComplete message. The capability of the relay device 300 is, for example, a frequency band (band) and a combination of frequency bands (band combination) compatible with (supported by) the relay device 300, uplink (from the relay device 300 to the base station device 200) setting, downlink (from the base station device 200 to the relay device 300) setting, physical layer setting, and the like.

Furthermore, in a case where a radio link failure is detected in a case where the SRB 1 is established but the security setting is not performed, for example, the NCR-MT 301 transitions from the RRC_CONNECTED state to the RRC_IDLE state, and transitions to the RRC_CONNECTED state again.

Furthermore, in a case where the SRB 1 is established and the security setting is also performed but either or both of an SRB 2 and a data radio bearer (DRB) are not established, the NCR-MT 301 performs the notification by the following method in addition to the four methods described above.
Notify by UE capability.

Note that the UE capability may include the capability of the relay device 300 described above.

In the sequence of FIG. 5, it is assumed that the NCR-MT 301 notifies that the own device is the relay device 300 by the RACH preamble in the RACH processing S101.

When it is recognized that a partner device of the RACH processing is the relay device 300 in the RACH processing S101, the base station device 200 starts control of the relay device 300. The base station device 200 transmits side control information to the relay device 300 (S102). The sidelink control information is transmitted in the control link L1 established in the RACH processing S101, and is transmitted by, for example, a physical downlink control channel (PDCCH). Furthermore, the sidelink control information includes, for example, information related to a symbol section for transmitting a single side band (SSB), a beam identifier (ID), information related to a section for turning off reception, information related to beam forming, and the like. The sidelink control information is an example of a control signal for controlling the relay processing of the relay device 300.

When the sidelink control information is received (S102), the NCR-MT 301 transmits a transfer start instruction to the NCR-Fwd 302 according to the sidelink control information (S103). The transfer start instruction includes starting transfer in the control mode. The control mode is a mode in which the NCR-MT 301 controls the NCR-Fwd 302, and the NCR-MT 301 instructs amplification, a transmission direction, a transmission timing of the received signal, and the like.

When the transfer start instruction (control mode) is received (S103), the NCR-Fwd 302 starts transfer of the signal of the base station device 200 under the control of the NCR-MT 301.

The base station device 200 transmits the sidelink control information to the relay device 300 at a predetermined timing (S104). The predetermined timing is, for example, at the time of transmission of data (immediately before transmission). The sidelink information includes, for example, information related to beam forming and amplification of a data signal to be transmitted. When the sidelink control information is received (S104), the NCR-MT 301 controls the NCR-Fwd 302 according to the sidelink control information.

When the data signal is received from the base station device 200 (S105), the NCR-Fwd 302 performs amplification and beam forming on the data signal according to an instruction of the NCR-MT 301, and transmits the data signal to the terminal device 100 (S106).

### <2. Case of Base Station Device 201 Not Having Control Function>

### <2.1 Transfer Processing in Autonomous Mode>

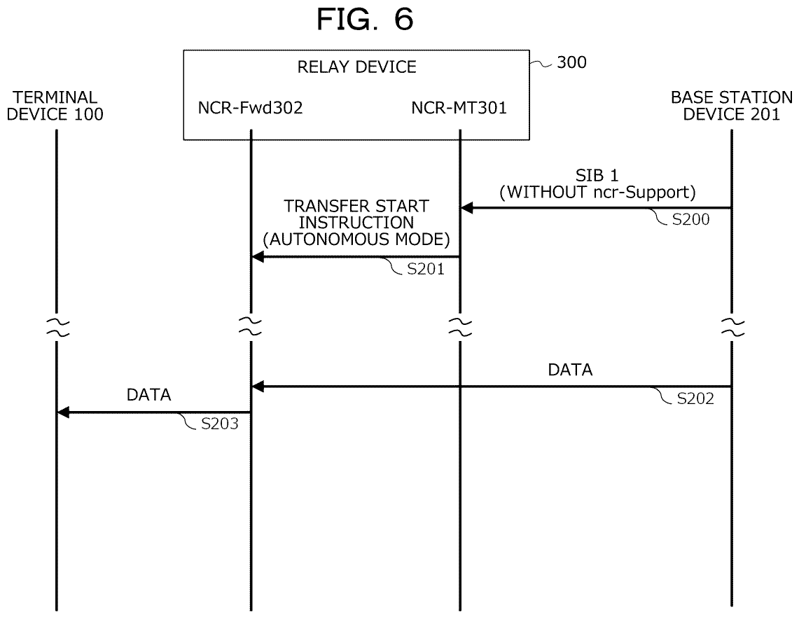

FIG. 6 is a diagram illustrating an example of a sequence of the relay processing in the relay device 300. In FIG. 6, the relay device 300 receives a signal from the base station device 201 that does not have the control function of the relay device 300.

The base station device 200 transmits the SIB 1 (S200). The SIB 1 transmitted by the base station device 201 does not include the NCR support information. For example, the base station device 201 does not have the control function of the relay device 300.

The NCR-MT 301 of the relay device 300 receives the SIB 1 (S200), and determines not to camp on the base station device 201. When it is determined not to camp on, the NCR-MT 301 transmits a transfer start instruction to the NCR-Fwd 302 so as to transfer the signal of the base station device 201 in the autonomous mode (S201). The autonomous mode is a mode in which the relay device 300 amplifies and transfers signals without depending on control from the base station device.

The autonomous mode is, for example, a mode in which beam forming is not performed and only one beam of the base station device 200 is transferred. The relay device 300 does not receive an instruction from the base station device 200 and performs beam control by a method unique to the relay device 300.

Note that, in FIG. 6, the relay device 300 performs the relay processing in the autonomous mode for the base station device for which it is determined not to perform camping on. However, the relay device 300 may not perform the relay processing (amplification and transfer) on the base station device for which it is determined not to perform camping on, and may discard signals to be received thereafter.

When a data signal is received from the base station device 201 (S202), the NCR-Fwd 302 amplifies the data signal and transmits the data signal to the terminal device 100 (S202). Note that, since the relay processing in the autonomous mode is performed, the NCR-Fwd 302 does not perform processing associated with the control function such as beam forming.

<2.2 Transfer Processing in Autonomous Mode (with Timing Information)>

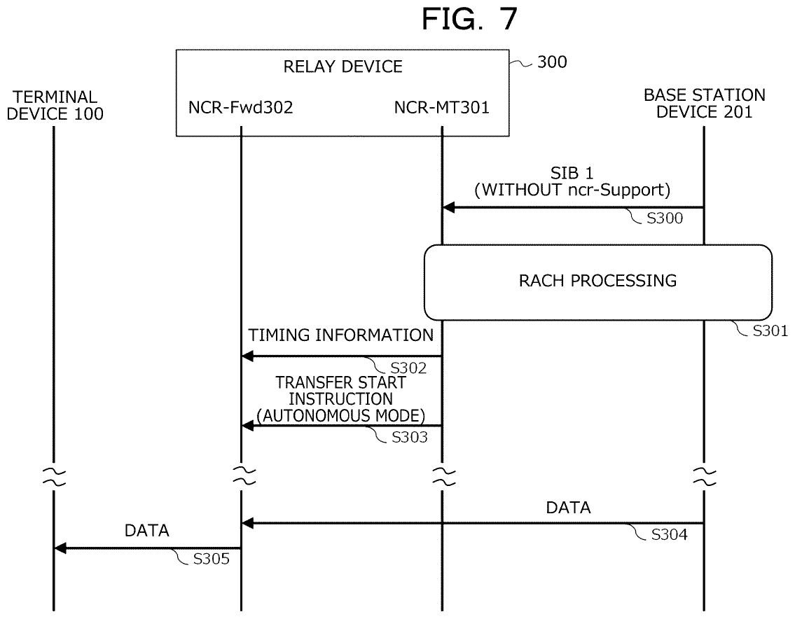

FIG. 7 is a diagram illustrating an example of a sequence of the relay processing in the relay device 300. In FIG. 7, the relay device 300 receives a signal from the base station device 201 having the control function of the relay device 300. Moreover, the relay device 300 performs the RACH processing in order to acquire a reception timing of the signal. By acquiring the reception timing, intermittent reception and the like may be executed, and power saving may be implemented.

The base station device 201 transmits the SIB 1 (S300). The SIB 1 transmitted by the base station device 201 does not include the NCR support information. For example, the base station device 201 does not have the control function of the relay device 300.

The NCR-MT 301 of the relay device 300 receives the SIB 1 (S300), and determines not to camp on the base station device 201. When it is determined not to camp on, the NCR-MT 301 performs the RACH processing (S301), and acquires the reception timing of the signal.

When the reception timing is acquired, the NCR-MT 301 includes the reception timing in timing information, and transmits the timing information to the NCR-Fwd 302 (S302). Then, the NCR-MT 301 transmits a transfer start instruction to the NCR-Fwd 302 so as to transfer the signal of the base station device 201 in the autonomous mode (S303). Note that the NCR-MT 301 may acquire tdd-UL-DL-ConfigurationCommon as another method of acquiring the reception timing.

When a data signal is received from the base station device 201 (S304), the NCR-Fwd 302 amplifies the data signal and transmits the data signal to the terminal device 100 (S305).

Note that the NCR-Fwd 302 (relay device 300) activates a communication device at a timing when the signal may be received according to the timing information, and turns off the communication device during other periods. For example, the communication device may include at least any one of the radio communication circuit 350 or the radio communication circuit 350 illustrated in FIG. 3. As a result, the relay device 300 may save power.

### <3. Case Where Signal of Base Station Device 200 Having Control Function is Received During Relay Processing in Autonomous Mode>

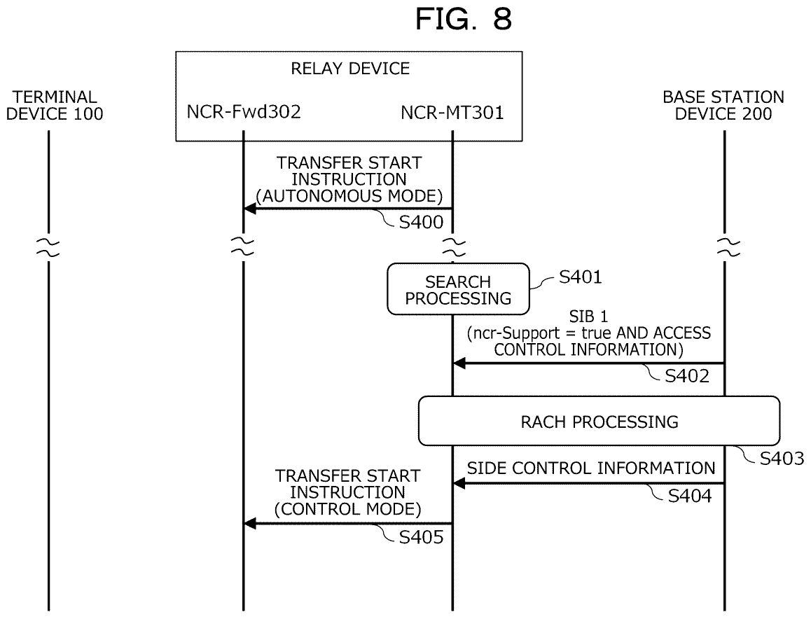

FIG. 8 is a diagram illustrating an example of a sequence of the relay processing in the relay device 300. In FIG. 8, the relay device 300 performs the relay processing of a signal of the base station device 201 in the autonomous mode. At this timing, the relay device 300 receives a signal from the new base station device 200.

For example, the NCR-MT 301 transmits a transfer start instruction to the NCR-Fwd 302 so as to transfer the signal of the base station device 201 in the autonomous mode (S400).

The NCR-MT 301 performs search processing of another base station device during the relay processing in the autonomous mode (S401). The search processing is processing of searching for a signal of a base station device other than the base station device 201 as an object of the autonomous mode. For example, the NCR-MT 301 executes the search processing regularly or irregularly in order to detect the base station device 200 having the control function. The search processing is executed, for example, after a predetermined time has elapsed from the start of the relay processing in the autonomous mode.

In the search processing S401, for example, the NCR-MT 301 searches for a carrier of the same center frequency. Furthermore, in the search processing S401, for example, the NCR-MT 301 may search for a carrier of a different center frequency. In this case, for example, order of the search follows a signal reported from the base station device, such as CellReselectionPriority.

The NCR-MT 301 detects the base station device 200 in the search processing S401, and receives the SIB 1 from the base station device 200 (S402). Subsequent processing from processing S402 to processing S405 is similar to the processing from processing S100 to processing S103 in FIG. 5.

Note that, for example, the relay device 300 may repeat the search processing without performing the relay processing in the autonomous mode until a base station device capable of performing the relay processing in the control mode is found. Furthermore, even during the relay processing in the control mode, the relay device 300 may perform the search processing and camp on another base station device again.

### <Reflection in Specifications>

An example of reflection in 3GPP specifications will be indicated. In the following drawings, additional specifications are indicated by bold underlines. Furthermore, specifications, chapter numbers, item numbers, names, values, insertion portions, and the like indicated in the additional specifications illustrated in the drawings are merely examples, and the present disclosure is not limited to this.

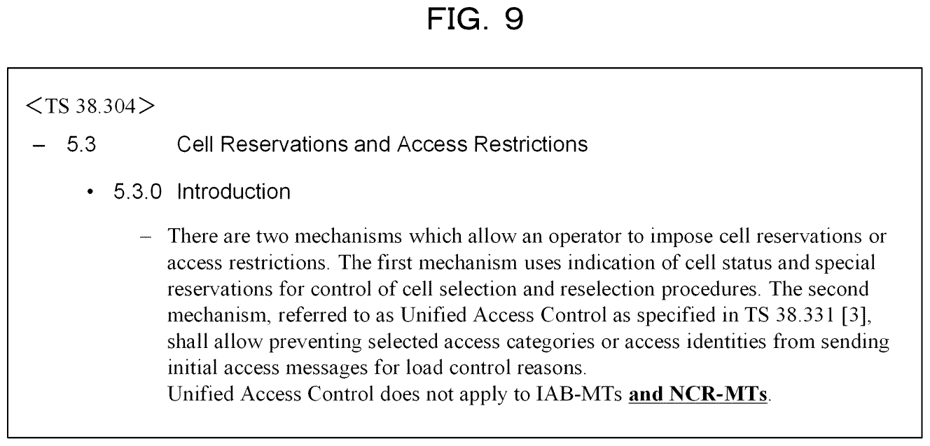

FIG. 9 is a diagram illustrating an example of a content change in TS 38.304. A fact that Unified Access Control is not applied to NCR-MTs is added to “5.3.0Introduction”.

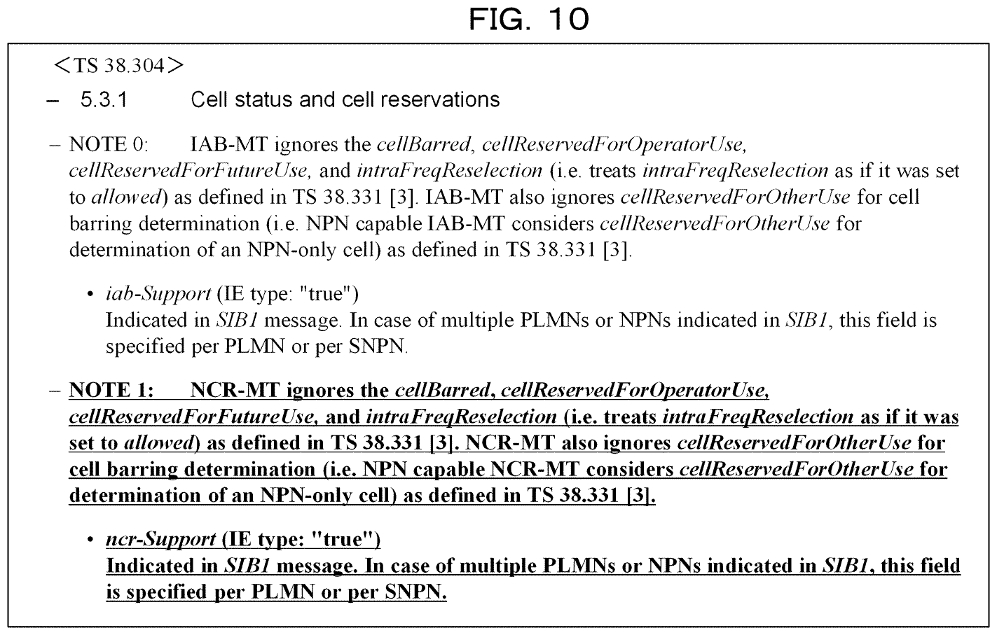

FIG. 10 is a diagram illustrating an example of a content change in TS 38.304. For NCR-MTs, content related to CellBarred similar to IAB-MTs is added. Note that, in a case where the relay device 300 does not have a network attached storage (NAS) function and does not perform authentication, ncr-Support is defined as a parameter common to a public land mobile network (PLMN) and a standalone non-public network (SNPN). In this case, description in the last three lines (“ncr-Support (IE type: “true”)” and thereafter) is unnecessary. However, in a case where the relay device 300 has the NAS function and performs authentication, since ncr-Support is defined for each PLMN and SNPN, the fact is added to the last three lines.

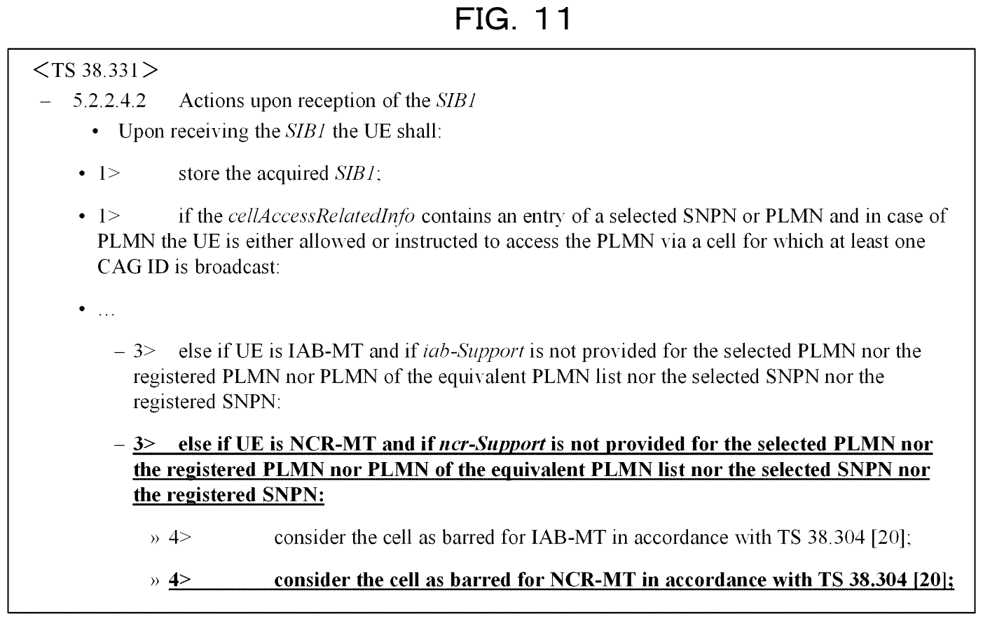

FIG. 11 is a diagram illustrating an example of a content change in TS 38.331. Processing at the time of reception of the SIB 1 in the relay device 300 is added to “5.2.2.4.2Actions upon reception of the SIB 1”.

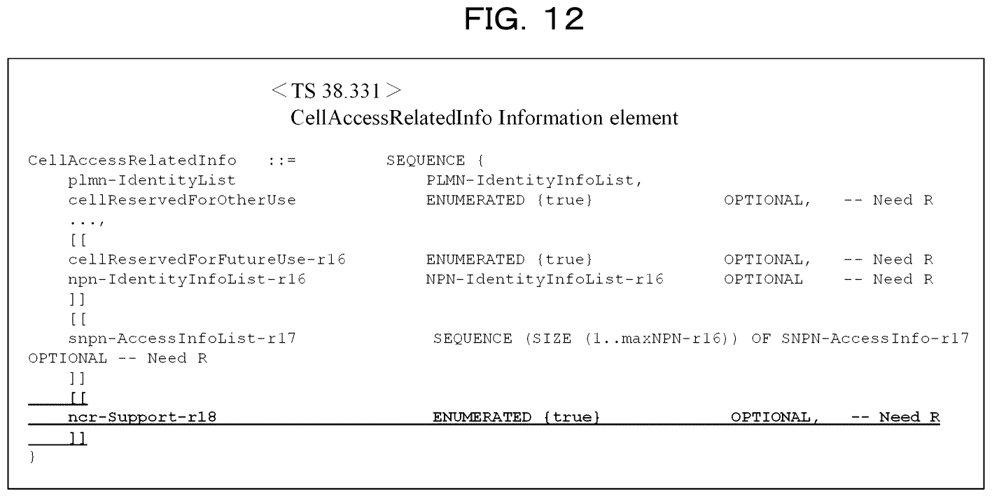

FIG. 12 is a diagram illustrating an example of a content change in TS 38.331. A definition of ncr-Support is added as “CellAccessRelatedInfo Information element” in “6 Protocol data units, formats and parameters (ASN.1)”.

### Other Embodiments

The requirements described in the first embodiment may be combined with each other. Furthermore, the requirements described in the first embodiment may be selectively used according to requirements of the radio communication system, a surrounding situation, a radio wave situation, and the like.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A relay device of relaying a signal received from a base station device to a terminal device, the relay device comprising:
a controller configured to determine whether or not to perform relay processing of a first signal transmitted by a first base station device under control of the first base station device according to support information that indicates whether or not the first base station device has a control function of the relay device; and
relay processor circuitry configured to perform the relay processing under the control of the first base station device in a case where the controller determines to perform the relay processing under the control of the first base station device,
wherein the relay processing includes amplification and transfer processing of the first signal.

2. The relay device according to claim 1, wherein,
in a case where the first base station device has the control function in the support information, the controller determines to perform the relay processing under the control of the first base station device.

3. The relay device according to claim 2, wherein
the support information is transmitted by the first base station device, and
the controller receives the support information.

4. The relay device according to claim 3, wherein
the first base station device transmits access restriction information related to access restriction to the first base station device, and
the controller acquires the access restriction information, and determines whether or not to perform the relay processing under the control of the first base station device according to the support information and the access restriction information.

5. The relay device according to claim 4, wherein,
in a case where access to the first base station device is prohibited in the access restriction information, the controller determines not to perform the relay processing under the control of the first base station device.

6. The relay device according to claim 5, wherein,
in a case where the access to the first base station device is not prohibited in the access restriction information and in a case where the first base station device has the control function in the support information, the controller determines to perform the relay processing under the control of the first base station device.

7. The relay device according to claim 1, wherein,
in a case where the controller determines not to perform the relay processing under the control of the first base station device,
the relay processor circuitry performs the relay processing of the first signal without depending on the control of the first base station device.

8. The relay device according to claim 1, wherein,
in a case where the controller determines not to perform the relay processing under the control of the first base station device,
the relay processor circuitry does not perform the relay processing of the first signal.

9. The relay device according to claim 7, wherein,
in a case where it is determined not to perform the relay processing under the control of the first base station device, the controller searches for a second signal transmitted by a second base station device other than the first base station device after a predetermined time has elapsed, and determines whether or not to perform relay processing under control of the second base station device when the second signal is received, and
in a case where the controller determines to perform the relay processing under the control of the second base station device, the relay processor circuitry stops the relay processing of the first signal and performs the relay processing under the control of the second base station device.

10. The relay device according to claim 8, wherein,
in a case where it is determined not to perform the relay processing under the control of the first base station device, the controller searches for a second signal transmitted by a second base station device other than the first base station device after a predetermined time has elapsed, and determines whether or not to perform relay processing under control of the second base station device when the second signal is received, and
in a case where the controller determines to perform the relay processing under the control of the second base station device, the relay processor circuitry performs relay processing under the control of the second base station device.

11. The relay device according to claim 7, wherein,
in a case where it is determined not to perform the relay processing under the control of the first base station device, the controller acquires timing information related to a transmission timing of a signal transmitted by the first base station device, and
the relay processor circuitry controls power according to the timing information, and performs the relay processing of the first signal without depending on the control of the first base station device.

12. The relay device according to claim 11, wherein
the controller performs random access channel (RACH) processing with the first base station device, and acquires the timing information.

13. The relay device according to claim 1, wherein,
the amplification and transfer processing includes:
in the relay processing under the control of the first base station device,
amplifying the received first signal, and
transmitting the amplified first signal to the terminal device by beam forming.

14. The relay device according to claim 1, wherein,
in a case where it is determined to perform the relay processing under the control of the first base station device, the controller is wirelessly coupled to the first base station device and receives a control signal that controls the relay device from the first base station device via the wirelessly coupled radio.

15. A base station device in a communication system that includes a relay device of relaying a signal received from the base station device to a terminal device, the base station device comprising:
communication processor circuitry that transmits, to the relay device, support information that indicates whether or not the own device has a control function of the relay device; and
a relay controller that transmits relay control information related to relay processing performed by the relay device and controls the relay processing performed by the relay device,
wherein the relay processing includes amplification and transfer processing of the signal.

16. A relay method implemented by a relay device of relaying a signal received from a base station device to a terminal device, the relay method comprising:
determining whether or not to perform relay processing of a first signal transmitted by a first base station device under control of the first base station device according to support information that indicates whether or not the first base station device has a control function of the relay device; and
performing the relay processing under the control of the first base station device in a case where a controller determines to perform the relay processing under the control of the first base station device,
wherein the relay processing includes amplification and transfer processing of the first signal.
